(19) United States
(12) Patent Application Publication
(10) Pub. No.: US 2013/0271888 A1
(43) Pub. Date: Oct. 17, 2013

(54) Photovoltaic System and Apparatus for Operating a Photovoltaic System

(71) Applicant: SMA SOLAR TECHNOLOGY AG, Niestetal (DE)

(72) Inventors: Andreas Falk, Kassel (DE); Gerold Schulze, Kassel (DE); Volker Bergs, Kassel (DE)

(73) Assignee: SMA Solar Technology AG, Niestetal (DE)

(21) Appl. No.: 13/862,638

(22) Filed: Apr. 15, 2013

(30) Foreign Application Priority Data
Apr. 16, 2012 (DE) 102012103289.0

(51) Int. Cl. H02H 3/02

(52) U.S. Cl. CPC H02H 3/02
USPC 361/93.1

(57) ABSTRACT

The disclosure relates to a PV system including at least one inverter coupled to a grid via an AC disconnecting element and at least one transformer. The PV system includes at least one PV sub-generator having at least one PV string connected to a DC connection region of the inverter via DC lines. The PV system includes protection devices including a DC short-circuiting switch for short-circuiting the at least one PV string and a reverse-current protection element connected downstream thereof. The protection device includes an AC short-circuiting switch arranged upstream of the AC disconnecting element.

### REFERENCE TO RELATED APPLICATIONS

This application claims priority to German Patent Application 10 2012 103 289.0, filed on Apr. 16, 2012, the contents of which are hereby incorporated by reference in its entirety.

### FIELD

The disclosure relates to a photovoltaic (PV) system comprising at least one inverter and at least one downstream transformer, which is connected to a grid for feeding electrical power via an AC voltage disconnecting element.

### BACKGROUND

In the case of relatively large PV systems, in particular power-plant systems, provision is generally made for the generated electrical power to be fed directly into a medium-voltage grid. The medium-voltage grid can be a 20 kilovolt (kV) system, for example. Such power-plant systems generally have a large number of PV modules, of which in each case a plurality of PV modules are connected in series to form so-called PV strings. Often, several of the PV strings are connected in parallel, wherein the group of PV modules contained in this parallel circuit of PV strings forms a closed generator unit, which is also referred to as PV sub-generator below.

In the case of larger power-plant systems, inverters that are usually positioned centrally or else distributed at several points within the PV system are provided. In particular, high power inverters can be subdivided into three regions, namely a DC (direct current) connection region, a power electronics part, which comprises one or more DC-to-AC converters, and an AC (alternating current)connection region. On the AC side, the inverters are connected to a transformer via an AC disconnecting element, which can be formed by a switching and/or protection element, for example. In this case, a transformer can be provided for each inverter, or it is possible for a plurality of inverters to be connected to one transformer, via separate primary windings.

Such a system design of a PV system is known, for example, from the article “Electrical Fault Protection for Large Photovoltaic Power Plant Inverter”, D. E. Collier and T. S. Key, Photovoltaic Specialists Conference, IEEE Conference Record, 1988. In case of various fault events which could result in a destruction of parts of the PV system, the AC disconnecting element is opened in order to disconnect the PV system from the medium-voltage grid. At least one DC disconnecting element is provided in the DC connection region, which DC disconnecting element is likewise opened in the event of a fault and thus disconnects the PV generator from the power part of the inverter.

As the power of the inverter(s) increases and the associated short-circuit power of the grid increases in conjunction with relatively low inductances of high-performance transformers, possible short-circuit currents within the inverter or other system parts increase if there is a fault within the PV system. Such a fault event can occur, for example, in a short circuit between the DC lines which connect the PV sub-generators to the DC connection region of the inverter. Furthermore, short circuits can occur within the DC connection region or may be caused by a defective semiconductor within one of the DC-to-AC converters in the power part of the inverter. In all of these cases, currents of unaffected PV sub-generators or currents originating from the grid by flowing via the AC voltage side via freewheeling diodes provided in the inverter into the PV system can result in destruction of the PV sub-generators and/or components of the inverter(s). Owing to the increasingly high currents on the DC side and on the AC side, which currents can flow in the event of a fault in the case of an increasingly growing system size, the time that elapses before the relatively sluggish or slow-switching AC disconnecting elements open is, under some circumstances, insufficient for protecting the components of the inverter and the PV sub-generators from being destroyed. In general, the consequences of faults on the DC side are limited by fuses in the DC connection region. Such fuses are located at the outputs of each PV sub-generator. However, such fuses are expensive and cause power losses.

Document DE 10 2009 038 209 A1 describes a low-voltage AC system, in particular a wind energy installation, in which energy from a generator is fed into a medium-voltage grid via voltage converters and a medium-voltage transformer. In this case, a short-circuiting switch is arranged between the voltage converter and the medium-voltage transformer in order to prevent overcurrents fed by the grid on the low-voltage generator-side in the event of a fault occurring on the generator side, for example an arc or a short circuit. As a result, it is possible to dispense with protection elements on the low-voltage side. Such an arrangement would, however, not protect a PV system against overcurrents that are caused by PV sub-generators not affected by the fault event.

### SUMMARY

One embodiment of the present disclosure comprises a PV system of the type mentioned at the outset and an operating method for such a PV system, in which components of the PV system are reliably protected in the event of a fault.

A PV system according to the disclosure of the type mentioned at the outset includes a protection device comprising a DC short-circuiting switch for short-circuiting the at least one PV string of the PV sub-generator. The protection device further comprises a reverse-current protection element connected downstream of the DC short-circuiting switch in the direction of energy flow during feeding. In one embodiment a protection device is provided to the at least one PV sub-generator, and an AC short-circuiting switch is arranged upstream of the AC disconnecting element in the direction of energy flow.

By closing the DC short-circuiting switches of the PV sub-generator, it is possible to suppress currents introduced by further PV sub-generators on the DC side in the event of a fault. The PV strings and the PV modules arranged in these strings are not overloaded by the short circuit produced by the DC short-circuiting switches since they are designed for this short-circuit current and the short circuit event represents a permissible working point on their current/voltage characteristic. The reverse-current protection means prevents high reverse currents from further PV sub-generators which have not yet been short-circuited or from the inverter from being able to flow into the DC short-circuiting switch. The closing of the AC short-circuiting switch can prevent currents with a notable order of magnitude flowing from the grid via the transformer into the inverter in the period of time in which the AC disconnecting element has not yet opened. This makes use of the fact that a shorter switching time can be achieved with AC short-circuiting switches than with AC disconnecting elements.

In an advantageous configuration of the PV system, the DC short-circuiting switch is a semiconductor switch and the reverse-current protection means is a reverse-current diode. In one embodiment the semiconductor switch and the reverse-current protection means are components of a boost converter, which is associated with the PV sub-generator. A protection device with such a design can act as a boost converter during operation of the PV system. As a result, relatively high voltages can be realized on the DC lines and ohmic (I²R) losses in these DC lines can be correspondingly reduced. This can be taken into consideration during design of the PV system insofar as the fact that DC lines with a relatively small cross section can be used, and therefore an associated material saving and thus cost saving can be made.

A method according to the disclosure for operating a PV system in the event of a fault, in particular in the event of the occurrence of a short circuit within the PV system, comprising short-circuiting PV strings by a DC short-circuiting device associated with a PV sub-generator. An AC output of at least one DC-to-AC converter of an inverter is short-circuited by an AC short-circuiting switch and the AC output is decoupled from a grid. The same advantages result as for the PV system according to the disclosure.

### BRIEF DESCRIPTION OF THE DRAWINGS

The disclosure will be explained in more detail with reference to example embodiments with the aid of three figures, in which:

FIG. 1 shows a schematic illustration of a PV system in a block circuit diagram;

FIG. 2 shows a block circuit diagram of a detail of a PV system, and

FIG. 3 shows a schematic illustration of a further example embodiment of a PV system in a block circuit diagram.

### DETAILED DESCRIPTION

The disclosure relates to a photovoltaic (PV) system comprising at least one inverter and at least one downstream transformer, which is connected to a grid for feeding electrical power via an AC voltage disconnecting element. The PV system comprises at least one PV sub-generator, which comprises in each case at least one PV string and which is connected to a DC connection region of the at least one inverter via DC lines. Furthermore, the invention relates to a method for operating a PV system in the event of a fault, in particular in the event of the occurrence of a short circuit within the PV system.

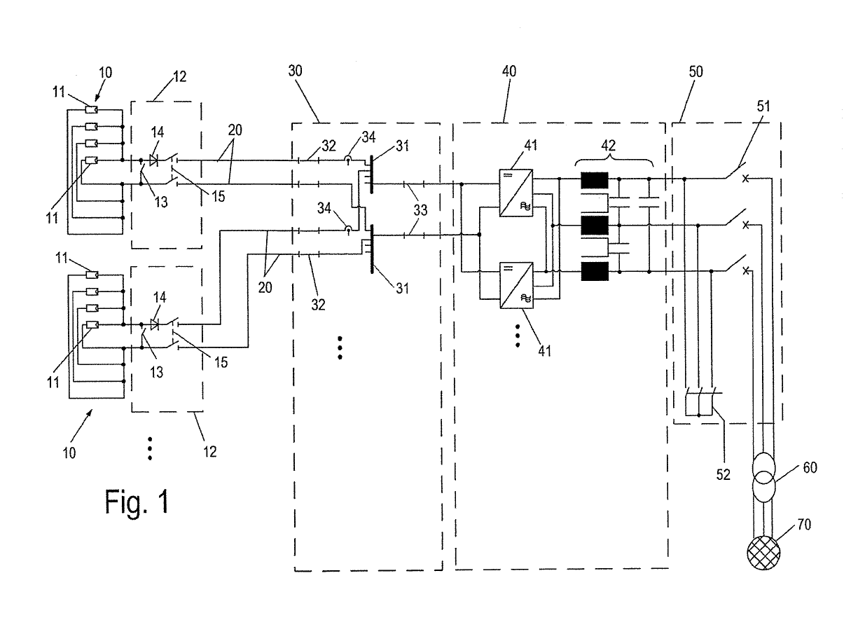

FIG. 1 shows, in the form of a block circuit diagram, a first example embodiment of a PV system. The PV system comprises a plurality of PV sub-generators 10, of which only one is illustrated in the figure for reasons of clarity.

The PV sub-generator 10 is connected to an inverter via DC lines 20, wherein the inverter is configured as a so-called central inverter in the example embodiment illustrated. The designation as a central inverter should not be understood to be restricted to the extent that this is a single inverter arranged geometrically centrally within the PV system. It is quite possible for a plurality of these central inverters to be provided within the PV system, and these can also be positioned in the region at the edge or border of the system. The central inverter is, however, central in the sense that a dedicated inverter is not provided for each PV sub-generator, as it is often the case in relatively small system concepts. However, the design of a PV system in accordance with the application, which will be explained in more detail below, can also be implemented using inverters that each have only one PV sub-generator associated.

The central inverter comprises three regions, namely a DC connection region 30, a power part 40 and an AC connection region 50. The central inverter is connected to the PV sub-generator 10 (illustrated in FIG. 1) and to the further PV sub-generators (not illustrated for reasons of clarity) via the DC connection region 30. The central inverter is coupled to a grid 70, for example a medium-voltage grid, via the AC connection region 50 and via a transformer 60. In one embodiment the grid 70 has a three-phase configuration, in the same way as the transformer 60, the power part 40 and the AC connection region 50. The transformer 60 can also be designed as a single-phase transformer. In the case of a transformer with a star connection on the low-voltage side, a neutral conductor can additionally be connected in the connection region of the inverter. This neutral conductor can be switched or cannot be switched in the event of a fault. The neutral conductor can be connected to a ground connection. For an energy supply system that has a different number of phases, it is of course possible to match the PV system according to the application correspondingly.

In the example embodiment illustrated, the PV sub-generator 10 comprises a plurality of PV strings 11 connected in parallel, which are each formed in a known manner by a plurality of series-connected PV modules. The illustration of the PV strings 11 in FIG. 1 by a single PV cell being drawn should be understood symbolically in this sense. In this case, a so-called string fuse (not shown) can be connected in series with each of the PV strings.

A DC short-circuiting switch 13, as part of a protection device 12, is associated with the PV sub-generator 10 between the outputs of the PV strings 11. In one embodiment, the protection device 12 is arranged physically adjacent to the PV strings 11. The DC short-circuiting switch 13 has a high current rise rate and a correspondingly high switching speed in the range of a few milliseconds (ms).

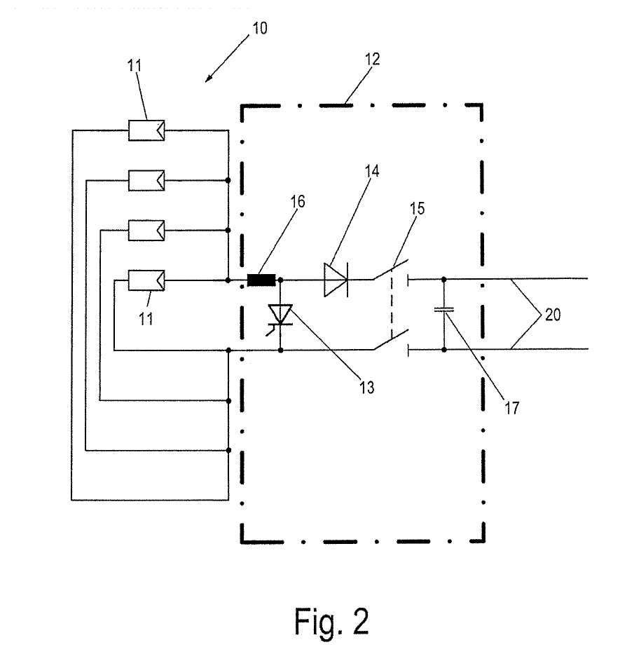

When viewed in the direction of energy flow (during feeding), a reverse-current protection means, in this case in the form of a reverse-current diode 14, and optionally a single-pole or two-pole DC switch disconnector 15 are arranged downstream of this DC short-circuiting switch 13. As in the illustrated example embodiment in FIG. 1, the reverse-current diode 14 can be used exclusively as a reverse-current diode or else, in its extended function, can be embodied as part of a DC-to-DC converter, as will be explained in more detail in connection with the example embodiment in FIG. 2. The DC switch disconnector 15 can also be used as reverse-current protection means given suitable actuation. The PV sub-generator 10 is connected to the remote central inverter via the DC lines 20 by the connections of the DC switch disconnector 15.

The DC lines 20 make contact with the central inverter in the DC connection region 30. The DC connection region 30 may provide cascaded DC busbars 31, via which all of the PV sub-generators 10 provided in the PV system are connected in parallel. The DC busbars 31 connect a plurality of the PV sub-generators 10. In order to monitor the incident radiation conditions and possibly control the PV system, in addition optionally measurement points 34, for example for current measurements, are also provided.

Furthermore, mounting locations 32 for protection elements and mounting locations 33 for DC switching elements are illustrated in FIG. 1. As will be explained in more detail below, these mounting locations 32, 33 are relevant for a system design of a PV system in accordance with the prior art. In the case of a PV system in accordance with the present disclosure, the fuse elements or DC disconnecting elements provided according to the prior art can be dispensed with and are replaced by line links, for example.

One or more DC-to-AC converters 41, of which only two are illustrated here for reasons of clarity, are arranged in the power part 40 of the central inverter. On the DC side, the DC-to-AC converters 41 make contact with the DC busbars 31 from the DC connection region 30. On the AC side, a filter arrangement 42 for shaping an output voltage to be as sinusoidal as possible is connected downstream of the DC-to-AC converters 41. In the example illustrated, the filter arrangement 42 comprises, by way of example, intercoupled inductances and capacitances in a delta arrangement. The filter arrangement 42 is often also referred to as a sine filter owing to its operation.

The three AC outputs of the power part 40 are routed to the transformer 60 in the AC connection region 50 via an AC disconnecting element 51 provided there. The AC disconnecting element 51 can be, for example, a contactor, a circuit breaker, a load disconnector or else comprise one or more fuses or a combination of these elements.

Furthermore, the AC connection region 50 comprises an AC short-circuiting switch 52, which is designed to short-circuit, on activation, the three outputs of the power part 40 upstream of the AC disconnecting element 51, when viewed in the feed/energy flow direction. The AC short-circuiting switch 52 is reproduced symbolically as a mechanical switch in the figure. In a modification of the PV system according to one embodiment, the AC short-circuiting switch 52 is a semiconductor switch, in order to ensure switching times as short as possible. The AC short-circuiting switch 52 is characterized by the fact that it can be closed within a very short period of time (for example within a millisecond). In the example embodiment illustrated, the AC short-circuiting switch 52 is arranged between the filter arrangement 42 and the AC disconnecting element 51.

In accordance with an operating method according to the application, in the event of the occurrence of a fault event within the PV system, provision is made for both the AC short-circuiting switch 52 on the AC-voltage side and the DC short-circuiting switches 13 on the DC-side of the PV sub-generators 10 to be closed. The fault event can in this case be identified automatically by a corresponding monitoring device, and the closing of the AC short-circuiting switch 52 and the DC short-circuiting switches 13 takes place in a manner driven by this monitoring apparatus. As an alternative and/or in addition, manual tripping of the AC short-circuiting switch 52 and the DC short-circuiting switches 13 can be provided.

At the same time as or close in time to the closing of the AC short-circuiting switch 52 and the DC short-circuiting switches 13, the AC disconnecting element 51 opens. If the AC disconnecting element 51 has fuses in the current path, in principle these fuses automatically cause a disconnection owing to the high short-circuit current flowing. Since, however, the fuses in all phases do not necessarily trip, in this case generally in addition a switching element is provided as part of the AC disconnecting element 51. Alternatively, the AC disconnecting element 51 can be formed by a circuit breaker, which disconnects all poles in the event of a short circuit automatically or in driven fashion.

A fault event can, for example, comprise a short circuit between two DC lines 20 on the path between a PV sub-generator 10 and the DC connection region 30. Such a short circuit results in high currents at the short circuit point. In this case, the current of the PV sub-generator 10 which is directly affected is not critical since the DC lines 20 are designed for this current. However, it is more critical that all of the other PV sub-generators 10 likewise contribute to the short-circuit current via the DC connection region 30. In addition, an additional short-circuit current contribution can flow from the grid 70 into the short circuit point via the power part 40 of the central inverter. In total, this can result in overloading of the DC lines 20 and therefore in the occurrence of fires or else in overloading and/or destruction of semiconductor switches or of freewheeling diodes, for example in the DC-to-AC converters 41 or further elements/component parts, which are not designed to carry such a high current. In this case, destruction can be a result of an excessively high level of lost heat or else a consequence of excessively high electromagnetic forces associated with the current. In the same way, a short circuit which exists as a result of an otherwise defective semiconductor switch in one of the DC-to-AC converters 41, can result in destruction of further semiconductor switches as a result of currents of the PV sub-generators 10 and currents from the grid 70.

Currents introduced on the DC side in the event of a short circuit are suppressed by the closing of the DC short-circuiting switches 13 in all the PV sub-generators 10 in accordance with the disclosure. The PV strings 11 and the PV modules arranged therein are not overloaded by the short circuit brought about by the DC short-circuiting switches 13 since they are designed for this short-circuit current and the short circuit event represents a permissible working point on their current/voltage characteristic. The reverse-current diode 14 in this case protects the DC short-circuiting switch 13 and the PV modules in the PV strings 11 from high reverse currents, which could otherwise flow through further PV sub-generators 10 or from the power part 40 into the DC connection region 30.

The actuation of the AC short-circuiting switch 52 prevents current of a notable order of magnitude from being able to flow from the grid 70 via the transformer 60 and the (still) closed AC disconnecting element 51 into the power part 40 of the central inverter. The short circuit situation brought about on the AC side does not represent an operating state that can be tolerated permanently since the grid 70, the transformer 60 and also the short-circuiting switch 52 are loaded to a level which is above a permanently tolerable degree owing to the short circuit event. However, the short circuit event is also only provided temporarily since, at the same time as or close in time to the driving of the AC short-circuiting switch 52, the opening of the AC disconnecting element 51 is also initiated. The AC disconnecting element opens corresponding to its inherent delay time after typically a few tens of milliseconds to a few hundred milliseconds. In addition, for the time period in which the AC short-circuiting switch 52 has already switched, but the AC disconnecting element 51 has not yet opened, the short-circuit current is limited by the transformation characteristics of the transformer 60.

The application makes use of the fact that a short circuit can be realized more quickly via semiconductor switches than interruption of the AC line compared to, for example, mechanical switches. The reason for this is that connecting and energy-transmitting elements such as the AC disconnecting element 51 are based on mechanical switches in order to minimize transmission losses. Given the requirements with respect to the currents and voltages to be switched, the mechanical switches inevitably have relatively high moving masses, which result in the inherent switching delay mentioned.

Owing to the use of the DC short-circuiting switches 13 and the AC short-circuiting switch 52, the fuse elements and disconnecting elements used in the prior art in the DC connection region 30 can be dispensed with and an in this sense direct connection of the PV sub-generators 10 to the DC inputs of the DC-to-AC converters 41 can be performed. The fuse elements, for example fusible links, provided in accordance with the prior art at the mounting locations 32 shown in FIG. 1 and the DC switch disconnectors provided in accordance with the prior art at the mounting locations 33 can be dispensed with, as a result of which a material saving is possible, which compensates for or even overcompensates for the additional material outlay involved for the DC short-circuiting switches 13 and the AC short-circuiting switch 52.

In addition, the DC short-circuiting switches 13 make it possible for the DC switch disconnectors 15 of the PV sub-generators 10 to only be actuated without a current load. Therefore, it is possible to use switches as DC switch disconnectors 15 which do not need to be designed for switching on load and which do not need to have any additional devices for arc quenching, for example. In an alternative configuration of the PV sub-generators 10, the DC switch disconnector 15 can also be dispensed with.

FIG. 2 illustrates, in the form of a block circuit diagram, a PV sub-generator 10 and an associated protection device 12, which PV sub-generator and protection device can be used, for example, in connection with the PV system illustrated in FIG. 1. Identical reference symbols denote identical or functionally identical elements in FIG. 2 to those in FIG. 1.

With respect to the design of the PV sub-generator 10, reference is made to the embodiment in FIG. 1. In contrast to the exemplary embodiment in FIG. 1, in FIG. 2 the DC short-circuiting switch 13 of the protection device 12 is represented by a semiconductor switch, in this case a thyristor, for example. Advantageously, a GTO (gate turn-off) thyristor is used in one embodiment in order that, after the occurrence of a short circuit, the short circuit can be canceled again. However, it is likewise possible to use an IGBT (insulated gate bipolar transistor) or a MOSFET (metal oxide semiconductor field effect transistor).

In the current path in which the reverse-current diode 14 is arranged as reverse-current protection means, an inductance 16 is arranged between the output of the PV strings 11 and the DC short-circuiting switch 13. A capacitance 17, which is connected to the cathode of the reverse-current diode 14, is arranged in parallel with the output. In the event of permanent activation of the DC short-circuiting switch 13, the DC short-circuiting switch likewise short-circuits the PV strings 11, as in the example embodiment shown previously. The interposed inductance 16 is in this case of no importance for this function.

In addition, the inductance 16, the DC short-circuiting switch 13 and the reverse-current diode 14, in conjunction with the capacitance 17, in the clocked (pulsed) operating mode of the DC short-circuiting switch 13 form a boost converter, i.e. a DC-to-DC converter, which makes it possible to convert the photovoltaic voltage supplied by the PV strings 11 into a higher output voltage, which is then applied to the DC line 20 via the DC switch disconnector 15. During operation of the PV system, the protection device 12 therefore acts as a boost converter and can be used to reduce ohmic losses (I²R) in the DC lines 20 as a result of a relatively high voltage on the DC lines 20. In this way, under certain circumstances, the total efficiency of the PV system can be positively influenced. When designing the PV system, this can be taken into consideration to the extent that DC lines 20 with a relatively small cross section can be used and therefore an associated material saving and thus cost saving can be made. A further advantage of the boost converters arranged in the region of the PV sub-generators 10 is that, by virtue of varying the voltage transformation ratio of the boost converters, a working point of the PV strings 11 can be set individually for each of the PV sub-generators 10. In this way, the PV sub-generators 10 can be operated at their respective optimum working point even when the PV system is partially shadowed.

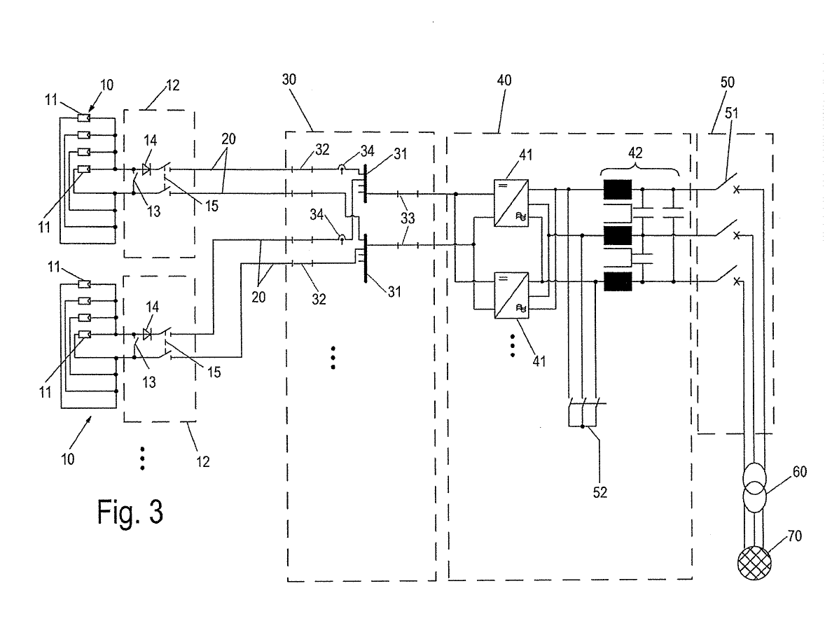

FIG. 3 shows, in the same way as FIG. 1, a further example embodiment of a PV system. Identical reference symbols in this figure identify identical or functionally identical elements to those in FIG. 1. Reference is made to the statements relating to the example embodiment shown in FIG. 1 for the basic design, in particular of the DC side of the PV system.

In contrast to the example illustrated in FIG. 1, the AC short-circuiting switch 52 is arranged between the AC output of the inverter 41 and the filter arrangement 42. It is advantageous here that, in the event of a short circuit, the level of the short-circuit current is limited not only by the transformation characteristics (for example leakage impedances) of the transformer 60, but also by transmission characteristics of the filter arrangement 42 until the AC disconnecting element 51 opens. As an alternative or in addition, in the arrangement of the AC short-circuiting switch 52 shown in FIG. 1 or 3, the level of the short-circuit current can also be restricted by internal current-limiting elements for a case in which there is no transformer connected upstream. In the case of excessive current limitation, however, there is the risk of the possibility of residual currents flowing into the inverter.

In principle, with respect to the arrangement of the AC short-circuiting switch 52 in relation to the AC disconnecting element 51 it is necessary to take into consideration the fact that the AC disconnecting element 51 is connected downstream of the AC short-circuiting switch 52 in the direction of energy flow during feeding. The arrangement in respect of the filter arrangement 42 and the transformer 60 can be varied taking into consideration the level of the short-circuit current.

1. A photovoltaic (PV) system comprising at least one inverter, which is configured to be coupled to a grid via an AC disconnecting element and at least one transformer for feeding electrical power from the PV system into the grid, and at least one PV sub-generator, which comprises at least one PV string connected to a DC connection region of the at least one inverter via DC lines via a protection device, the protection device comprising:
an inverter input protection device, comprising:
a DC short-circuiting switch configured to short-circuit the at least one PV string of the PV sub-generator; and
a reverse-current protection element connected downstream of the DC short-circuiting switch in the direction of energy flow during feeding electrical power into the grid, wherein the DC short-circuiting switch and the reverse-current protection element are associated with the at least one PV sub-generator; and
an inverter output protection circuit comprising an AC short-circuiting switch arranged upstream of the AC disconnecting element in the direction of the energy flow during feeding electrical power into the grid.

2. The PV system according to claim 1, wherein the DC short-circuiting switch comprises a semiconductor switch and the reverse-current protection element comprises a reverse-current diode.

3. The PV system according to claim 2, wherein the semiconductor switch and the reverse-current diode are components of a boost converter, which is associated with at least one PV sub-generator.

4. The PV system according to claim 3, further comprising an inductance and/or a capacitance as part of the boost converter associated with the at least one PV sub-generator.

5. The PV system according to claim 1, wherein the inverter input protection circuit further comprises a DC switch disconnector.

6. The PV system according to claim 1, wherein the DC lines which lead from the at least one PV sub-generator to the inverter, are connected directly to DC inputs of at least one DC-to-AC converter in a DC connection region of at least one inverter, wherein no interposed fuse or disconnecting elements are provided.

7. The PV system according to claim 1, wherein the AC short-circuiting switch comprises at least one semiconductor switch.

8. A method for operating a PV system, in which, in the event of a short circuit within the PV system, the method comprising:
short-circuiting of PV strings by a DC short-circuiting switch;
short-circuiting of an AC output of at least one DC-to-AC converter of an inverter by an AC short-circuiting switch; and
decoupling the AC output from a grid.

9. The method according to claim 8, wherein decoupling the AC output from the grid comprises opening a connection between the AC output and the grid between the AC short-circuiting switch and the grid.
